(19) United States
(12) Patent Application Publication
(10) Pub. No.: US 2016/0078682 A1
(43) Pub. Date: Mar. 17, 2016

(54) COMPONENT MOUNTING WORK SUPPORT SYSTEM AND COMPONENT MOUNTING METHOD

(71) Applicant: KAWASAKI JUKOGYO KABUSHIKI KAISHA, Kobe-shi, Hyogo (JP)

(72) Inventors: Shigekazu Shikoda, Akashi-shi (JP); Naohiro Nakamura, Akashi-shi (JP); Shinichi Nakano, Suita-shi (JP); Masahiko Akamatsu, Himeji-shi (JP); Shingo Yonemoto, Kakogawa-shi (JP); Daisuke Tokai, Akashi-shi (JP); Takashi Koumoto, Kakogawa-shi (JP)

(21) Appl. No.: 14/787,198

(22) PCT Filed: Apr. 23, 2014
(86) PCT No.: PCT/JP2014/061403

§ 371 Date: Oct. 26, 2015

(30) Foreign Application Priority Data
Apr. 24, 2013 (JP) 2013-091419

(51) Int. Cl. G06T 19/00; H04N 13/04; G02B 27/01; G06T 7/00

(52) U.S. Cl. CPC G06T 19/006; G06T 7/001; G06T 7/0044; H04N 13/044; G02B 27/0172; G06T 2200/04; G06T 2207/20221; G02B 2027/0178; G02B 2027/0134; G02B 2027/0138; G02B 2027/014

(57) ABSTRACT

The system has an imaging unit configured to image a work space at a viewpoint position in a visual line direction of a worker together with a workpiece on which a component is mounted, a position attitude information obtaining unit configured to obtain a position attitude information which indicates a relative position attitude relation between the viewpoint of the worker and the workpiece in the work space, a virtual image generating unit configured to generate a three-dimensional virtual image indicating the component after being mounted at the viewpoint position in the visual line direction, an image composing unit configured to generate a composite image by superimposing the virtual image on a real image of the work space, and a display unit configured to display the composite image. According to the system, efficiency of the component mounting work can be considerably improved by using the mixed reality technology.

### TECHNICAL FIELD

The present invention relates to a component mounting work support system for supporting mounting work of a component using a mixed reality technology, particularly relates to a component mounting work support system suitable for supporting component tack welding work and a component mounting method using the system.

### BACKGROUND ART

Conventionally, when a component such as a hanging metal fitting is welded to a workpiece, a marking 42 is previously performed to a position of a workpiece 41 on which a component 41 is mounted as illustrated in FIG. 7(a), and a worker performs tack welding of the component 41 with the marking 42 as a mark (FIG. 7(b)).

However, marking work itself is sometimes difficult to perform when the dimension of a workpiece on which a component is mounted is large or when a workpiece has a curved surface, and therefor there is a case that a lot of time is consumed for the marking work.

Also, there is also a problem that, when marking is performed before forming a workpiece, a marking position is dislocated due to plastic deformation upon forming.

Also, when a component mounting position is marked and information of a component to be mounted is written down, an operator sometimes make a mistake in the mounting direction upon tack welding. As a result, there is a case that the regression work occurs and work efficiency declines.

Also, in an inspection after a workpiece is mounted, there is a problem that the quality of mounting state cannot be judged intuitively since it is necessary to confirm the mounting state with respect to drawings or the like.

Note that, recently, a mixed reality (MR) technology that an image of a virtual space is superposed on an image of a real space at an optional viewpoint and a composite image obtained in this manner is presented to an observer is attracting attention as an image technology for integrating the real world with the virtual world seamlessly in real time (Patent Documents 1-4).

### RELATED ART DOCUMENTS

### Patent Documents

[Patent Document 1] Japanese Patent Application Laid-Open No. 2005-107968

[Patent Document 2] Japanese Patent Application Laid-Open No. 2005-293141

[Patent Document 3] Japanese Patent Application Laid-Open No. 2003-303356

[Patent Document 4] Japanese Patent Application Laid-Open No. 2008-293209

### SUMMARY OF INVENTION

### Problems to be Solved by the Invention

Then, an object of the present invention is to solve the above-mentioned problems in component mounting work to a workpiece and to provide a component mounting work support system so as to considerably improve work efficiency by using the mixed reality technology, and a component mounting method using the system.

### Means for Solving the Problems

In order to achieve the objects above, the present invention is a component mounting work support system for supporting a component mounting work, including: an imaging unit configured to image a work space at a viewpoint position in a visual line direction of a worker together with a workpiece on which a component is mounted; a position attitude information obtaining unit configured to obtain a position attitude information which indicates a relative position attitude relation between the viewpoint of the worker and the workpiece in the work space; a virtual image generating unit configured to generate a three-dimensional virtual image indicating the component after being mounted at the viewpoint position in the visual line direction of the worker; an image composing unit configured to generate a compo site image by superimposing the virtual image on a real image of the work space imaged by the imaging unit; and a display unit configured to display the composite image.

Also, it is preferable that the position attitude information obtaining unit has a marker for mixed reality installed temporarily in a predetermined relative position with respect to a reference point on the workpiece.

Also, it is preferable that the position attitude information obtaining unit has a position direction measuring device configured to measure the viewpoint position and the visual line direction of the worker and a position of the workpiece.

Also, it is preferable that the virtual image is generated including an allowable mounting error in the mounting work.

Also, it is preferable that the component mounting work support system further includes an error determining portion configured to display an inconsistent point of the real image of the component after being mounted and the virtual image on the display portion.

In order to achieve the above-mentioned objects, the present invention is a component mounting method using a component mounting work support system for supporting a component mounting work, including: an imaging step which images a work space at a viewpoint position in a visual line direction of a worker together with a workpiece on which a component is mounted; a position attitude information obtaining step which obtains a position attitude information which indicates a relative position attitude relation between the viewpoint of the worker and the workpiece in the work space; a virtual image generating step which generates a three-dimensional virtual image indicating the component after being mounted at the viewpoint position in the visual line direction of the worker based on the position attitude information; an image composing step which generates a composite image by superimposing the virtual image on a real image of the work space imaged in the imaging step; and a display step which displays the composite image.

Also, it is preferable that the position attitude information obtaining step includes a marker installing step which temporarily installs a marker for mixed reality in a predetermined relative position with respect to a reference point on the workpiece.

Also, it is preferable that the component of the real image is positioned to the component of the virtual image while confirming a position relation between the component as the virtual image displayed in the composite image and the component as the real image displayed in the composite image.

### Advantageous Effect of the Invention

By the component mounting work support system and the component mounting method using the system according to the present invention, the conventional marking work becomes unnecessary or the marking work is simplified by using the mixed reality technology, and therefore work efficiency of component mounting can be considerably improved.

### BRIEF DESCRIPTION OF THE DRAWINGS

FIG. 1 is a block diagram illustrating a schematic configuration of a component mounting work support system according to an embodiment of the present invention.

FIG. 2 is a schematic view illustrating the schematic configuration of the component mounting work support system in FIG. 1.

FIG. 3 is an enlarged perspective view illustrating a marker member of the component mounting work support system in FIG. 1.

FIG. 4 is a schematic view illustrating how to mount a component on a workpiece by using the component mounting work support system in FIG. 1.

FIG. 5 is a block diagram illustrating a schematic configuration of a modified example of the component mounting work support system in FIG. 1.

FIG. 6 is a schematic view illustrating a schematic configuration of another modified example of the component mounting work support system in FIG. 1.

FIG. 7 is a schematic view illustrating a conventional component mounting work.

### EMBODIMENT OF THE INVENTION

Hereunder, a component mounting work support system according to an embodiment of the present invention will be described. Note that, although the component mounting work to be supported by the system is typically a component tack welding work to a workpiece, various component mounting works to a workpiece other than the component tack welding work can also be supported.

As the component mounting work support system according to the embodiment uses the mixed reality technology, first, the mixed reality technology will be briefly explained.

As previously mentioned, the mixed reality technology is a video technology which superimposes an image of a virtual space on an image of a real space at an arbitrary viewpoint and presents a composite image obtained in this manner to an observer so as to integrate the real world with the virtual world seamlessly in real time.

Namely, the mixed reality technology provides an observer with a composite image obtained by composing a real space image and a virtual space image generated according to a viewpoint position and a visual line direction of the observer. It can have the observer perceive the scale of a virtual object by the sense of actual dimension so that the observer feels that the virtual object actually exists in the real world.

The mixed reality technology enables the observer to see computer graphics (CG) from an arbitrary position or angle by moving actually, not by operating the same with a mouse or a keyboard. Namely, it is possible that CG is placed in a designated place by an image positioning technology and the CG is seen from various angles using a see-through type head mount display (HMD), for example.

In order to express a mixed reality space (MR space), it is necessary to obtain a relative position attitude relation between a coordinates system in the real space to be a reference determining the position attitude of a virtual object to be superimposed on the real space and a coordinate system of an imaging portion (camera coordinate system).

As an appropriate image positioning technology therefore, for example, what utilizes a magnetic sensor, an optical sensor, or an ultrasonic sensor, or what utilizes a marker, a gyro, or the like can be given.

Here, note that the marker (also called “land mark”) is an index used for positioning an image, and the position attitude of a camera can be estimated by image processing by imaging the marker arranged in the real space with a camera (imaging device) mounted on HMD.

Namely, the marker having a predetermined visual feature is placed in known three-dimensional coordinates in the real space, and the marker included in the real image is detected, and the position attitude of the camera (imaging device) is calculated from a two-dimensional image position of a constitutional element (center or vertex of the marker) of the marker detected and the known three-dimensional coordinates.

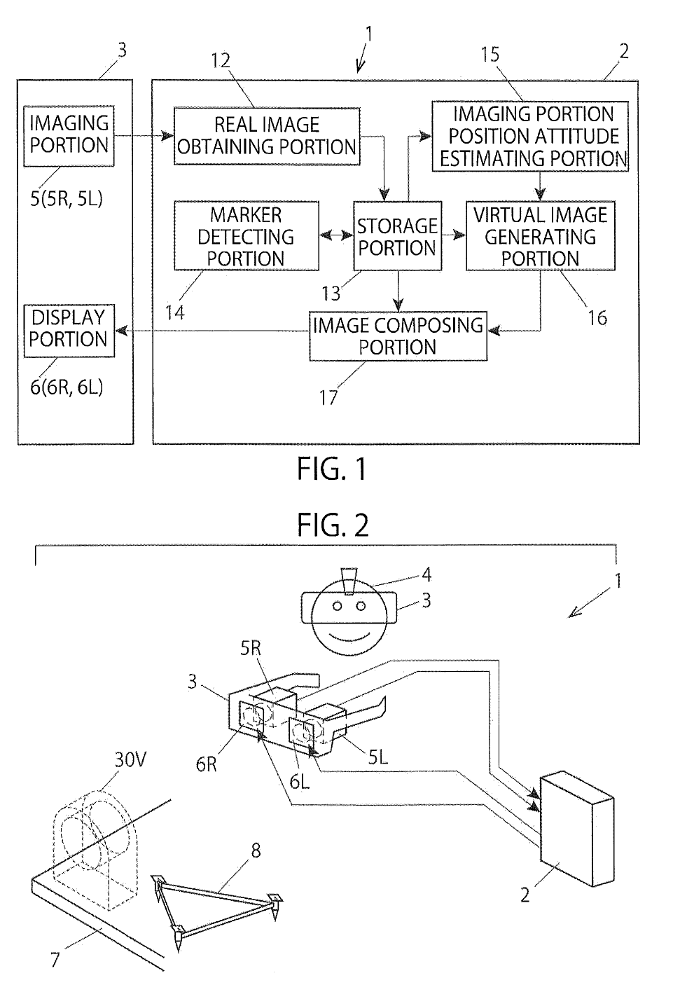

The component mounting work support system of the embodiment utilizes the above-mentioned mixed reality technology, and hereunder, the configuration will be described referring to FIGS. 1 and 2.

As illustrated in FIGS. 1 and 2, a component mounting work support system 1 according to the embodiment has a system body 2 and a head mount display (HMD) 3 for performing data communication with the system body 2, and a marker member 8.

The system body 2 of the component mounting work support system 1 is configured by a computer having CPU, RAM, ROM, an external storage device, a storage medium drive device, a display device, an input device, and the like.

As illustrated in FIG. 2, the HMD 3 having an imaging portion 5 and a display portion 6 is mounted on the head of a worker 4. Two pairs of the imaging portion 5 and the display portion 6 are provided. The imaging portion 5R and the display portion 6R are for the right eye, and the imaging portion 5L and the display portion 6L are for the left eye. By the configuration, a parallax image can be presented to the right eye and the left eye of the worker 4 who wears the HMD 3 on his/her head, and a MR image (composite image) can be displayed three-dimensionally.

The imaging portion 5 of the HMD 3 images a marker member 8 for MR installed temporarily in a marker installing step on a workpiece 7 and also images the workpiece 7 on which a component is mounted (imaging step). The marker member 8 is to be installed in a predetermined relative position with respect to a reference point on the workpiece 7. Note that, a virtual image 30V of a component is illustrated by a broken line in FIG. 2.

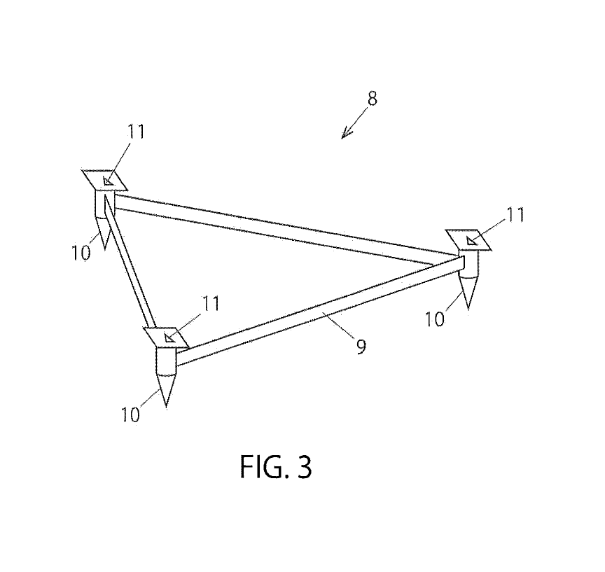

As illustrated in FIG. 3, the marker member 8 according to the embodiment has a triangle frame portion 9, each supporting portion 10 provided on the lower surface of each vertex of the triangle frame portion 9, and each marker for mixed reality 11 provided on the upper surface of each vertex of the triangle frame portion 9.

As illustrated in FIG. 1, a real image of the real space obtained by the imaging portion 5 of the HMD 3 is input to a real image obtaining portion 12 of the system body 2. The real image obtaining portion 12 outputs data of the input real image to a storage portion 13 of the system body 2.

The storage portion 13 holds necessary information for presenting and processing a MR image (composite image) and reads out and updates the information according to processing.

Also, the system body 2 has a marker detecting portion 14 for detecting the marker 11 provided to the marker member 8 from the real image held by the storage portion 13.

Next, a detection result of the marker 11 of the marker member 8 arranged on the workpiece 7 as a real object is sent to an imaging portion position attitude estimating portion 15 from the marker detecting portion 14 via the storage portion 13. The imaging portion position attitude estimating portion 15 estimates a position attitude of the imaging portion 5 of the HMD 3 in the object coordinate system of the workpiece 7 itself as the reference coordinate system, based on the detection result of the marker 11 (position attitude information obtaining step).

Here, the marker member 8, the marker detecting portion 14, and the imaging portion position attitude estimating portion 15 configure a position attitude information obtaining unit in the component mounting work support system 1.

The position attitude of the imaging portion 5 of the HMD 3 estimated by the imaging portion position attitude estimating portion 15 is sent to a virtual image generating portion 16. The virtual image generating portion 16 generates a three-dimensional virtual image 30V of a virtual object seen from the position attitude of the imaging portion 5 based on the position attitude of the imaging portion 5 sent from the imaging portion position attitude estimating portion 15, namely the viewpoint position and the visual line direction of the worker 4 (virtual image generating step).

Here, in the component mounting work support system 1, a virtual image 30V of a component after being mounted on the workpiece 7 by a predetermined tack welding work is generated in this virtual image generating portion 16. The virtual image 30V of the component after being mounted is provided with a thickness of allowable mounting error and displayed.

The virtual image 30V of the component after being mounted generated in the virtual image generating portion 16 is sent to an image composing portion 17 of the system body 2. The image composing portion 17 superimposes the virtual image 30V sent from the virtual image generating portion 16 on the real image of the workpiece 7 before mounting the component held by the storage portion 13 so as to generate the MR image (composite image) (image composing step).

The MR image (composite image) generated in the image composing portion 17 is output to the display portion 6 of the HMD 3 (display step). Thereby, the MR image that the image of the real space according to the position attitude of the imaging portion 5 of the HMD 3 and the image of the virtual space are superimposed mutually is displayed on the display portion 6 of the HMD3, enabling the worker 4 wearing the HMD 3 on his/her head to experience the mixed real space.

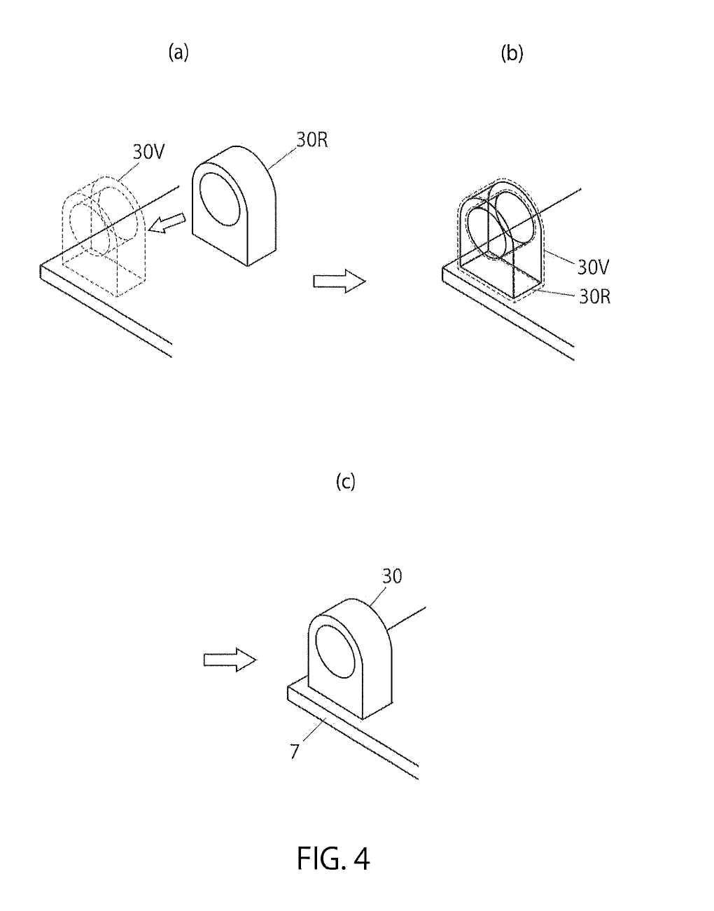

Then, as illustrated in FIG. 4(a), the worker 4 confirms the position relation between a component as the virtual image 30V displayed in the MR image and a real image 30R of a real component displayed in the MR image, and positions the component of the real image 30R to the component of the virtual image 30V as illustrated in FIG. 4(b).

In this state, the worker tack welds a component 30 to the workpiece 7 as illustrated in FIG. 4(c). Thereby, the predetermined component 30 can be mounted in a predetermined position and in a predetermined direction without requiring previous marking work.

As stated above, by the component mounting work supporting system 1 according to the embodiment, the component 30 can be positioned easily by positioning the component of the real image 30R to the component of the virtual image 30V and efficiency of mounting work of the component 30 can be enhanced considerably.

Also, as the worker 4 can see the virtual image 30V of the component 30 after being mounted prior to the mounting work, the worker can unmistakably select the component 30 to be mounted and also the worker never makes a mistake in the mounting direction of the component 30. Thereby, the reduction work becomes unnecessary and efficiency of the mounting work of the component 30 can be considerably enhanced.

Note that the component mounting work support system 1 according to the embodiment can support the mounting work itself as mentioned above and also can be used for checking the state after mounting the component.

Namely, by imaging the workpiece 7 via the HMD 3 after mounting the component 30 on the workpiece 7, a composite image of the real image 30R of the actual component 30 mounted on the workpiece 7 and the component as the virtual image 30V can be seen.

Accordingly, the worker (inspector in this case) 4 can judge the quality of mounting state of the component 30 intuitively by a pseudo visual inspection by visually confirming a deviation between the real image 30R and the virtual image 30V without collation work against drawings. Thereby, time for inspecting the mounting state of the component 30 can be considerably reduced.

Also, the component mounting work support system 1 according to the embodiment also can support the marking work to the workpiece 7. Namely, by imaging the workpiece 7 via the HMD 3, the virtual image 30V of the component 30 in the state of being mounted on the workpiece 7 can be seen so as to be superinterposed on the real image of the workpiece 7. Then, the worker 4 performs marking work in accordance with the virtual image 30V of the component 30 displayed on the display portion 6 of the HMD 3. Thereby, the marking work can be performed easily even when the dimension of the workpiece 7 is large or when the workpiece 7 has a curved surface.

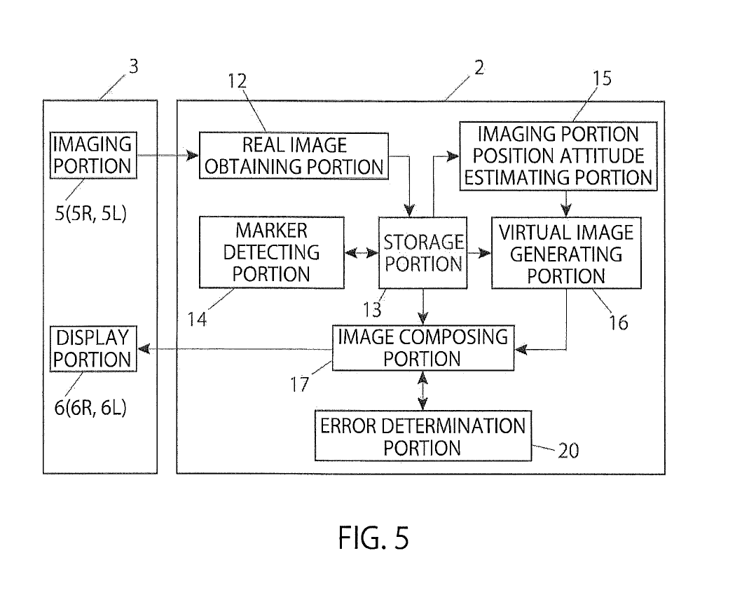

Next, a modified example of the above mentioned embodiment will be described referring to FIG. 5.

A component mounting work support system according to the modified example further comprises an error determining portion 20 for detecting an inconsistent portion of the real image 30R of the component 30 after being mounted and the virtual image 30V of the component 30 after being mounted by pattern matching so as to display the same together with the information indicating the degree of the inconsistency on the display portion 6 of the HMD 3, as illustrated in FIG. 5.

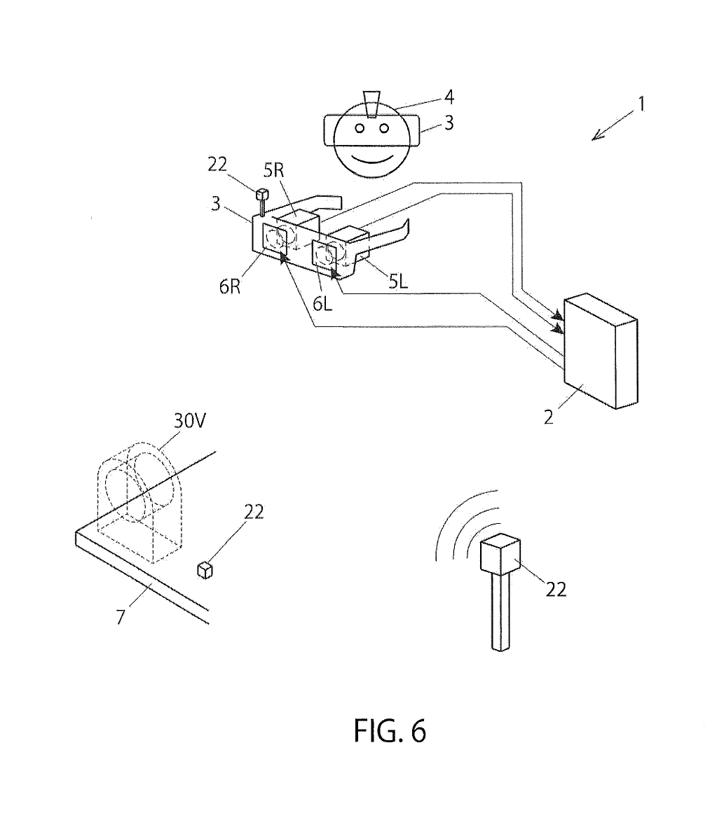

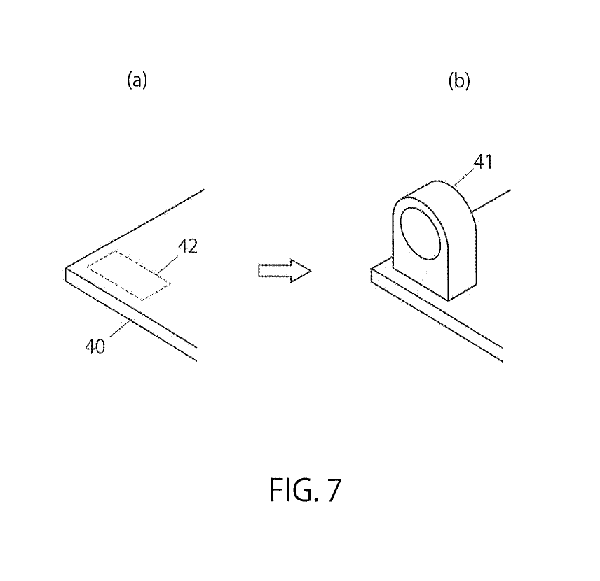

Note that, although the position attitude information obtaining unit in the component mounting work support system 1 is configured by the marker member 8, the marker detecting portion 14, and the imaging portion position attitude estimating portion 15 in the above-mentioned embodiment and its modified example, instead of this, or in addition to this, a position direction measuring device 22 for measuring the visual position and visual line direction of the worker 4 and the position of the workpiece 7 can also be provided, as illustrated in FIG. 6. As the position direction measuring device 22 of this type, an ultrasonic sensor, or a magnetic/optical position measuring sensor can be used, for example.

Also, the marker for mixed reality 11 may be a type of being stuck on the workpiece 7 prior to the tack welding of the component 30.

Also, instead of the marker for mixed reality 11 to be separately prepared as mentioned above, part of the workpiece 7 itself (for example, a corner portion as a geometric characteristic point) can also be utilized as a reference point for positioning (a kind of marker).

### DESCRIPTION OF REFERENCE NUMERALS

1 . . . component mounting work support system

2 . . . system body

3 . . . head mount display (HMD)

4 . . . worker

5, 5R, 5L . . . imaging portion of HMD

6, 6R, 6L . . . display portion of HMD

7 . . . workpiece

8 . . . marker member

9 . . . frame member of marker member

10 . . . supporting portion of marker member

11 . . . marker

12 . . . real image obtaining portion

13 . . . storage portion

14 . . . marker detecting portion

15 . . . imaging portion position attitude estimating portion

16 . . . virtual image generating portion

17 . . . image composing portion

18 . . . holding member

20 . . . error determining portion

22 . . . position direction measuring device

30 . . . component

30R . . . real image of component

30V . . . virtual image of component

1. A component mounting work support system for supporting a component mounting work, comprising:
an imaging unit configured to image a work space at a viewpoint position in a visual line direction of a worker together with a workpiece on which a component is mounted;
a position attitude information obtaining unit configured to obtain a position attitude information which indicates a relative position attitude relation between the viewpoint of the worker and the workpiece in the work space;
a virtual image generating unit configured to generate a three-dimensional virtual image indicating the component after being mounted at the viewpoint position in the visual line direction of the worker;
an image composing unit configured to generate a composite image by superimposing the virtual image on a real image of the work space imaged by the imaging unit; and
a display unit configured to display the composite image.

2. The component mounting work support system according to claim 1, wherein the position attitude information obtaining unit has a marker for mixed reality installed temporarily in a predetermined relative position with respect to a reference point on the workpiece.

3. The component mounting work support system according to claim 1, wherein the position attitude information obtaining unit has a position direction measuring device configured to measure the viewpoint position and the visual line direction of the worker and a position of the workpiece.

4. The component mounting work support system according to claim 1, wherein the virtual image is generated including an allowable mounting error in the mounting work.

5. The component mounting work support system according to claim 1 further comprising an error determining portion configured to display an inconsistent point of the real image of the component after being mounted and the virtual image on the display portion.

6. A component mounting method using a component mounting work support system for supporting a component mounting work, comprising:
an imaging step which images a work space at a viewpoint position in a visual line direction of a worker together with a workpiece on which a component is mounted;
a position attitude information obtaining step which obtains a position attitude information which indicates a relative position attitude relation between the viewpoint of the worker and the workpiece in the work space;
a virtual image generating step which generates a three-dimensional virtual image indicating the component after being mounted at the viewpoint position in the visual line direction of the worker based on the position attitude information;
an image composing step which generates a composite image by superimposing the virtual image on a real image of the work space imaged in the imaging step; and
a display step which displays the composite image.

7. The component mounting method according to claim 6, wherein the position attitude information obtaining step includes a marker installing step which temporarily installs a marker for mixed reality in a predetermined relative position with respect to a reference point on the workpiece.

8. The component mounting method according to claim 6, wherein the component of the real image is positioned to the component of the virtual image while confirming a position relation between the component as the virtual image displayed in the composite image and the component as the real image displayed in the composite image.

9. The component mounting work support system according to claim 2, wherein the position attitude information obtaining unit has a position direction measuring device configured to measure the viewpoint position and the visual line direction of the worker and a position of the workpiece.

10. The component mounting work support system according to claim 2, wherein the virtual image is generated including an allowable mounting error in the mounting work.

11. The component mounting work support system according to claim 3, wherein the virtual image is generated including an allowable mounting error in the mounting work.

12. The component mounting work support system according to claim 9, wherein the virtual image is generated including an allowable mounting error in the mounting work.

13. The component mounting work support system according to claim 2 further comprising an error determining portion configured to display an inconsistent point of the real image of the component after being mounted and the virtual image on the display portion.

14. The component mounting work support system according to claim 3 further comprising an error determining portion configured to display an inconsistent point of the real image of the component after being mounted and the virtual image on the display portion.

15. The component mounting work support system according to claim 9 further comprising an error determining portion configured to display an inconsistent point of the real image of the component after being mounted and the virtual image on the display portion.

16. The component mounting work support system according to claim 4 further comprising an error determining portion configured to display an inconsistent point of the real image of the component after being mounted and the virtual image on the display portion.

17. The component mounting work support system according to claim 10 further comprising an error determining portion configured to display an inconsistent point of the real image of the component after being mounted and the virtual image on the display portion.

18. The component mounting work support system according to claim 11 further comprising an error determining portion configured to display an inconsistent point of the real image of the component after being mounted and the virtual image on the display portion.

19. The component mounting work support system according to claim 12 further comprising an error determining portion configured to display an inconsistent point of the real image of the component after being mounted and the virtual image on the display portion.

20. The component mounting method according to claim 7, wherein the component of the real image is positioned to the component of the virtual image while confirming a position relation between the component as the virtual image displayed in the composite image and the component as the real image displayed in the composite image.
